(19) United States
(12) Patent Application Publication
(10) Pub. No.: US 2009/0311438 A1
(43) Pub. Date: Dec. 17, 2009

(54) Method and Device for Functionalising the Surfaces of Adhesive Closing Parts

(76) Inventor: Konstantinos Poulakis, Hildrizhausen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/226,527

(22) PCT Filed: May 26, 2007
(86) PCT No.: PCT/EP2007/004709

§ 371 Date: Oct. 21, 2008

(30) Foreign Application Priority Data
Jun. 22, 2006 (DE) 006028581.6

(51) Int. Cl. B05D 3/06; B05D 3/14; B05C 11/00

(52) U.S. Cl. 427/540; 427/553; 427/535; 118/620

(57) ABSTRACT

The invention relates to a method for functionalising the surfaces of adhesive closing parts which form, with correspondingly formed adhesive closing parts, an adhesive closure that can be repeatedly opened and closed. The surface energy of the adhesive closing part is modified by means of a proton and/or electron exchanging medium, especially in the form of donors or collectors, using high energy in such a way that the physicochemical properties of the material of the adhesive closing part can be adjusted without a coating and with ageing resistance, by the attachment of functional groups of the exchanging medium to the adhesive closing part material. The invention also relates to a device for carrying out one such method.

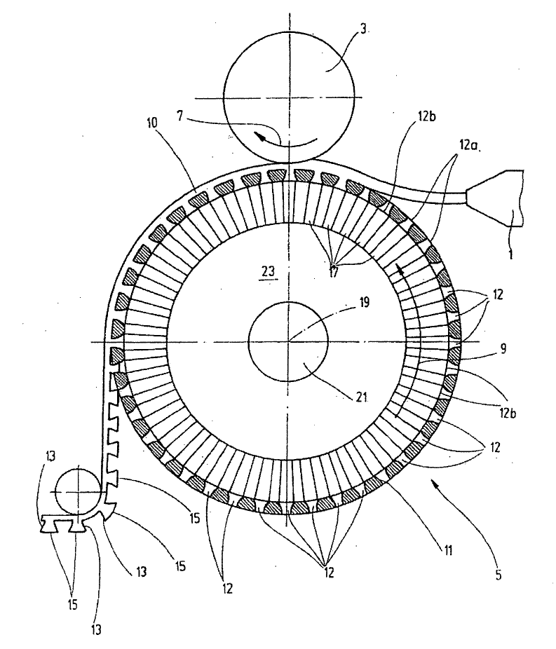

The invention relates to a method and device for functionalizing the surfaces of adhesive closing parts which form an adhesive closure that can be repeatedly opened and closed with correspondingly made adhesive closing parts.

EP 1 082 031 discloses a method for producing adhesive closing elements having adhesive closing parts of plastic materials, the adhesive closing part with the adhesive closing elements being provided at least partially with a coating whose thickness is chosen such that it does not adversely affect the subsequent operation of the adhesive closure. The coating on the adhesive closing part is formed by way of a so-called sol-gel method, preferably based on SiO₂ and/or TiO₂ modified SiO₂. The coating which has been applied by way of the indicated sol-gel method is foam-repellant; this entails advantages in the event the known adhesive closing part is being used when seat cushion parts are foamed. Although the applied coating is made nanocomposite, i.e., the layer thickness can be extremely small, in particular has only a few molecule thicknesses of the respective coating agent, this coating is not resistant to wear and thus is not resistant to ageing.

EP 1 077 620 B1 discloses an adhesive closing part, in particular for foaming for cushion parts of vehicle seats, in their production, on one side of the adhesive closing part an adhesive primer being applied. If the known adhesive closing part consists of a polyamide material, the adhesive primer is formed from resorcinol and/or at least one of its derivatives or, if the adhesive closing part consists of a polyolefin material, polyurethane or a polymer is used as the adhesive primer which is formed by way of re-crosslinking of hardenable resins. In this way, on the adhesive closing part as an additional coating a type of primer layer is formed which creates a high-strength connection to the respective foam material, even without use of the corresponding adhesive agents. This known solution to an application coating can also wear off.

To counteract this, DE 101 23 205 A1 has described a method for producing an adhesive closing part with a plurality of adhesive closing elements made in one piece with a backing, in which interlocking heads of the adhesive closing elements are provided with a head part of an additional material which can be hardened, in the form of a duroplastic molding mass, preferably in the form of an acrylate, especially preferably in the form of a urethane diacrylate. Provided that this urethane molding mass material has cured, an adhesive closing part is formed which on the one hand can easily withstand high temperatures and mechanical stresses, and, on the other, with a corresponding configuration leads to improved adhesive and peeling strength values. The high-strength additional coating which has been applied in this way on the adhesive closing elements is geometrically correspondingly large; this in turn conflicts with the desired miniaturization of the adhesive closing parts for which attempts, are currently being made to accommodate several thousand adhesive closing elements on a square centimeter of the carrier material of the adhesive closing part.

Proceeding from this prior art, therefore the object of the invention is to further improve the known method and associated devices such that miniaturizable adhesive closing parts are functionalized by surface technology in large throughput amounts in a cost-favorable manner such that a plurality of surface and structure properties of the most varied type can be produced with only one basic concept of treatment steps. This object is achieved by a method with the features of claim 1 and a device according to the configuration of features of claim 12.

In the method according to the invention, by means of a proton and/or electron exchange medium, in particular in the form of donors and collectors, the surface energy of the adhesive closing part is modified using high energy such that the physicochemical properties of the material of the adhesive closing part can be adjusted to be free of coatings and resistant to ageing by functional groups of the exchange medium attaching to the material of the adhesive closing part.

So-called Bronsted acids which act as proton donors and so-called Lewis bases which as donors can release electrons to other materials, such as to the plastic material of an adhesive closing part, have proven to be especially versatile to use. Furthermore there are collectors which accumulate protons and/or electrons in the plastic material of the adhesive closing part and which comparably to a redox action influence the surface energy of the adhesive closing part such that in turn it becomes possible for functional groups of exchange media to interact with the adhesive closing part in such a way as to determine function using high energy.

By functional groups of the exchange medium attaching to the material of the adhesive closing part in terms of the surface and in this respect intruding into the material of the adhesive closing part, an essentially coating-free structure is achieved, so that functionalization of the surface can be done on a small scale; this in turn supports the desired miniaturization for the adhesive closing parts in addition to their adhesive closing elements. Since the functional groups attach to the adhesive closing part in the molecular range, and in this respect interact with the otherwise plastic material of said closing part, this manner of action is resistant to ageing so that it need not be feared that the desired surface modification will be lost after a longer embedding time for the adhesive closing parts before their use in the production of the user. The physicochemical properties to be set are defined within a wide framework. Thus the adhesive closing part can be functionally adjusted in terms of its hardness or softness, as also with respect to the desired temperature resistance. Resistance to chemicals of any type can likewise be functionally adjusted, such as a desired reaction pattern with third products, for example, in the form of polyurethane foam, the parent material in the production of seat part cushioning.

By the attachment of chemical functional groups to the material of the adhesive closing part, in this regard a specific interaction can be achieved with the respective part on which the adhesive closing part is to be used. For example, it is possible, by the attachment of the corresponding functional groups, to make the adhesive closing part flame-resistant; one criterion of use for the respective adhesive closing part, if it is used in the fields of aeronautics and astronautics. If the respective functional group has luminophore portions, the respective adhesive closing part can be easily used in the creative design field in order, for example, to enable luminescent color designs. The indicated change of the surface energy moreover makes it possible to achieve improved adhesion of the corresponding adhesive closing parts with the formation of the adhesive closure, for which otherwise capillary technologies (DE 102 07 194 C1) which are complex to implement are described in the prior art.

Furthermore, the electrical discharge properties of the adhesive closing part in current transport or other information transport can be improved by way of the functional groups to be used. The plurality of possible applications is potentially not covered at present and will be the topic of further technical development using the above described method according to the invention.

A preferred device for implementing the method is one according to the configuration of features of claim 12, whereby the adhesive closing elements of the adhesive closing part can be produced by means of a mold screen, whereby on one side of the mold screen the plastic material for the closure elements can be supplied to mold openings of the screen, and whereby on the opposite side of the mold screen, preferably in situ the exchange medium can be supplied to the mold openings. In an especially cost-effective manner this device allows implementation of the production method according to the invention and a controlled process sequence. With this device large numbers of adhesive closing parts with surface modification can be more or less continuously produced in controlled production.

Other advantageous embodiments of the method according to the invention are the subject matter of the other dependent claims.

The single figure shows by way of example a side view, highly schematically simplified, and partially cut away, of a device for executing the method according to the invention.

The figure schematically shows parts of a device for executing the method according to the invention, with an extruder head 1 as the supply device, in particular for the thermoplastic material which is in the plastic or liquid state, and which is supplied, as a strip whose width corresponds to that of the adhesive closing part to be produced, to the gap between a pressure tool and a molding tool. The pressure tool is a pressure roll 3. The molding tool is a molding roll designated as a whole as 5. Both rolls are driven in the directions of rotation indicated in the figure with curved arrows 7 and 9 so that between them a conveyor gap is formed through which the plastic strip is conveyed in the transport direction, while at the same time in the gap as the shaping zone the plastic strip is shaped into the backing 10 of the adhesive closing part and the backing 10 on the side adjoining the molding roll 5 acquires the shape which is necessary for forming the interlocking means by the shaping elements of the molding roll 5.

For this purpose the molding roll 5 on the periphery has a screen 11 with individual mold cavities 12. One such mold cavity 12 which is bordered on both sides by mold openings 12a, b is preferably regularly distributed with other mold cavities 12 along the molding roll 5 with its screen 11 on the external peripheral side, the distribution and number being freely selectable. The respective mold cavity is made as a rotation hyperboloid so that respectively shaped stem parts 13 are formed which, with their respective base end, are connected in one piece to the strip-like carrier material 10 and whose other free end terminates in a peripherally widened head part 15. Both the stem part 13 and also the head part 15 each form an adhesive closing element for the adhesive closing part as a whole which, with the correspondingly shaped respective closure parts of another adhesive closing part which is not detailed, forms an adhesive closure which can be repeatedly opened and closed. Closures formed in this way have also become known under the trade name Velcro® closures.

The molding roll 5 is provided with openings in the form of media channels 17 which are oriented in terms of their longitudinal alignment to the center 19 as the axis of rotation of the molding roll 5. Within the molding roll 5 and in a concentric arrangement to it, there is a high energy source which is designated as 21 and which is shown symbolically. Furthermore, between the exterior jacket of the high energy source 12 and the interior periphery of the molding roll, there is an empty space which is used for supply and temporary storage of the exchange medium, and optionally the physical parameters of this empty and working space, for example, in the form of pressure and temperature, moisture content, etc., can be adjusted in addition. Furthermore, the possible supply of gas media and fluid media for implementing the method takes place via the pertinent empty or working space 23, for example, in order to accelerate the progress of the pertinent work. Flushing media can be supplied by way of the media channels 17 and also by way of the space 23 in order to remove potential residues from the overall production device during processing according to the method.

Polyolefins have proven especially well suited as the plastic material for the respective adhesive closing part to be produced. This group includes, for example, polyethylenes, polypropylenes, polybutenes, as well as polyisobutenes and poly(4-methyl-1-pentene)s, polymers of the higher α-olefins, such as poly(1-hexene), poly(1-octene), or poly(1-octadecene). These polyolefins should also include copolymers of different olefins, for example, those of ethylene with propylene. Another good feedstock for the adhesive closing parts to be produced is polyester.

Proton and/or electron exchange media are substances and groups of substances according to the follow chemical reference list, the so-called hard bases being designated as I, the soft bases II and the boundary cases of bases being designated as III. The hard acids are designated as IV, the soft acids V and the boundary cases of suitable acid materials are designated as VI.

I
H₂O OH⁻ F⁻
AcO SO₄²⁻ Cl⁻
CO₃²⁻ NO₃⁻ ROH
RO⁻ R₂O NH₃
RNH₂ SiOH
II
R₂S RSH RS⁻
I⁻ R₃P (RO)₃P
CN⁻ RON CO
C₂H₄ C₆H₆
H⁻ R⁻
III
ArNH₂ C₅H₅N
N₃⁻ Br⁻
NO₂⁻
IV
H⁺ Li⁺ Na⁺
K⁺ Mg²⁺ Ca²⁺
Al³⁺ Cr²⁺ Fe³⁺
BF₃ B(OR)₃ AlMe₃
AlCl₃ AlH₃ SO₃
RCO⁺ CO₂
HX
(hydrogen-binding molecules)
V
Cu⁺ Ag⁺ Pd²⁺
Pt²⁺ Hg²⁺ BH₃
GaCl₃ I₂ Br₂
CH₂ carbenes
VI
Fe²⁺ CO²⁺ Cu²⁺
Zn²⁺ Sn²⁺ Sb³⁺
Bi³⁺ BMe₃ SO₂
R₃C⁺ NO⁺ GaH₃
C₆H₅⁺

The classification is done according to the pattern that hard acids like to combine with hard bases, and soft acids with soft bases. The transitions between media designated as hard and soft are fluid, and this classification is intended fundamentally to provide only a rough idea and information about the action of the exchange media. Thus, for example, the potential proton release which occurs in Bronsted acid-base reactions is classified as a hard acid. The soft bases as so-called donors are in turn characterized in that several electrons or electron pairs in particular can be released in order in this way to be able to undertake surface functionalization for the adhesive closing part. For influencing the functionalization of the surface of the adhesive closing part, basically so-called collectors are available which in the manner of a redox reaction can pick electrons and/or protons out of the plastic material of the adhesive closing part in order to exert an influence; only the degree of functionalization which can be achieved in this way clearly takes second place to the proton and/or electron donors.

The desired surface modification can be further optimized by using a high energy source. In addition to using microwave radiation or-another high frequency field, the use of plasmas is possible. Possible plasma sources are DC voltage glow discharges such as high frequency discharges and those of a microwave nature. In order to reduce the thermal burden on the plastic material to be produced, in particular microwave discharge is recommended since the hardware cost for this is low, coupling without an electrode is possible, and, as a result of the high degree of ionization of the plasma, short process times are ensured; this is critical for in situ production of the adhesive closing part.

Such a plasma source would then be the high energy source designated as 21 as shown in the figure. A plurality of conceivable plasma modification processes can be carried out by virtue of the substrate position of the adhesive closing part in the mold cavities 12 of the mold screen 11. Thus the device shown in the figure is possible, for example, for a so-called in-plasma process in which the surface to be functionalized is located directly in the plasma zone. Likewise a so-called down-stream process would be conceivable in which a process gas is routed through a plasma zone and then can be supplied to the substrate as an adhesive closing part with its free head ends on adhesive closing elements. In particular, by adjusting the distance by way of the drum diameter of the molding roll 5, the thermal load for the substrate in the form of the adhesive closing part thus can be set low.

If the process gas used in the plasma zone should be reacted too quickly or completely all at once, a so-called afterglow process is possible, an inert carrier gas, for example, in the form of nitrogen gas being routed through the plasma zone and activating the process gas which can be supplied only downstream from the plasma zone. The working gas which is then activated, that is, indirectly, is used for the desired surface modification.

Since the drum-like production device can be sealed on the drum ends, routing of the process gas can be undertaken and adjusted in this respect by way of suitable inlets and outlets (not shown) in the empty or working space 23. To accelerate the process it can be advantageous to supply the process gas under the correspondingly high pressure into the space 23. Instead of a plasma generation source, for the production method according to the invention there can also be a dielectric barrier discharge, with a modified field source as a high energy source 21 which from the middle of the molding roll 5 builds up a dielectric field in the direction of the top of the substrate of the adhesive closing part. Furthermore, a treatment gas mixture is more or less continuously delivered into the empty and working chamber 23; it consists preferably of a carrier gas and a reducing gas and/or an oxidizing gas at a pressure which in this case can be more or less equal to the atmospheric pressure. The oxidizing gases here are in particular CO₂ or N₂O and the reducing gas is H₂. It has also proven favorable to settle the content of the oxidizing gas in the mixture in a range from 50 to 2,000 ppmv and the content of the reducing gas is preferably in a mixture in the range of values from 50 to 30,000 ppmv.

With the latter surface treatment method, amino, amido and/or imido groups and compounds can be used in particular as electron donors, which as a functional group on the top of the adhesive closing part delivers an NH3 group which with other functional groups allows a so-called asymmetrical urea bond which has another reactive group on which the polyurethane of the foam material in the cushion foam region can be settled; this leads to exceptionally good binding of the adhesive closing part in the mold foam in this way. By way of a corresponding adhesive closing part an appropriate covering material can then be again detachably joined to the foamed-in adhesive closing part which forms the asymmetrical urea bond to the indicated foam material.

In addition to production use of a revolving screen as shown in the figure, it is also possible to wind the mold screen arrangement in one plane and then the mold screen can be routed through the respective devices which then generate the corresponding surface modification, as described above. In particular, the screen can then be made as a conveyor belt over deflection rolls with an upper and a lower strand, the upper strand being used for shaping and the lower strand being used for removing the adhesive closing part from the individual mold cavities.

Nor does the adhesive closing part as shown in the figure need to be provided with head ends which are peripherally widened in order thus to offer the possibility of interlocking action. Rather modern adherence systems can also acquire a surface modification in this way. Thus, for example, DE 100 65 819 C1 shows a method for producing adhesive closing parts in which a carrier material in at least one partial region of its surface is provided with adhesive closing elements or adhesive elements which project out of its plane, in which a plastic material which forms the elements is applied to the carrier element as a carrier part 10, the elements being made at least in a partial region without a molding tool, in which the plastic material is deposited in droplets which are delivered in sequence by means of at least one application device. Although the application device by way of its nozzle delivers plastic material with a droplet volume of only a few picoliters, in this way a fast process sequence can be implemented so that an adhesive closing part is generated in an extremely short time. An adhesive closing part which has been produced in this way also can be surface-modified with the described method.

The device shown in the figure can also be miniaturized in terms of the mold cavities 12 such that adhesive elements can be produced whose adherence takes place mainly by means of van-der-Waals forces. Such a closure system is shown, for example, in DE 10 2004 012 067 A1. In spite of the high degree of miniaturization achieved in this way, with the pertinent solution according to the invention it is then possible to modify these nano-adhesive closing parts relative to their surface as specified. The above described device is especially suited in terms of the front side of the head closure material to influencing the respective adhesive closing part. But fundamentally all components of the closure part can optionally be functionalized in terms of their surface with different devices; this also applies especially to the rear side of the backing of the adhesive closing part facing away from the elements or to the top of the stem material which extends between the backing and the bottom of the closure head. For this functionalization of the surface the adhesive closing part with the component or component side to be functionalized is to be supplied open, that is, in an exposed manner, to the functionalization source; this can take place in closed systems but also in open systems in passage for more or less continuous functionalization.

1. A method for functionalizing the surfaces of adhesive closing parts which form an adhesive closure that can be repeatedly opened and closed with correspondingly made adhesive closing parts, characterized in that by means of a proton and/or electron exchange medium, in particular in the form of donors and collectors, the surface energy of the adhesive closing part is modified using high energy such that the physicochemical properties of the adhesive closing part material can be adjusted to be free of coatings and resistant to ageing by functional groups of the exchange medium attaching to the material of the adhesive closing part.

2. The method according to claim 1, characterized in that the process of attachment of the functional groups is supported by the influence of high energy, using
high frequency radiation such a microwave radiation,
electrical fields such as a dielectric barrier discharge, and
plasma-supported fields as are formed when using a low pressure or high pressure plasma.

3. The method according to claim 1, characterized in that the process of attachment of the functional groups can be controlled using inert gases and/or reaction gases.

4. The method according to claim 1, characterized in that the process of attachment of the functional groups can be controlled by means of temperature gradients and/or pressure gradients.

5. The method according to claim 1, characterized in that the plastic material of the adhesive closing part to be functionalized is a thermoplastic, in particular polyolefins and/or polyesters.

6. The method according to claim 1, characterized in that basically acting electron donors are used as the trigger medium.

7. The method according to claim 1, characterized in that amino, amido and/or imido groups and compounds are used as basic electron donors.

8. The method according to claim 7, characterized in that using the basic electron donors, asymmetrical bonds with the parent material of the adhesive closing part are formed, preferably asymmetrical urea bonds are formed.

9. The method according to claim 8, characterized in that the asymmetrical urea bond is formed by attachment of the respective closure part to foam materials, such as polyurethane foam.

10. The method according to claim 1, characterized in that binding of the functional groups to the adhesive closing part takes place in situ.

11. The method according to claim 1, characterized in that the respective adhesive closing part is produced by means of a screening process.

12. A device for executing the method according to claim 1, characterized in that the closure elements (13, 15) can be produced by means of a mold screen (11), that on one side (12a) of the mold screen (11) the plastic material for the closure elements (13, 15) can be supplied to the mold openings (12) of the screen, and that on the opposite side of the mold screen (11), preferably in situ, the exchange medium can be supplied to the mold openings (12b).
